(19) United States
(12) Patent Application Publication
(10) Pub. No.: US 2012/0144743 A1
(43) Pub. Date: Jun. 14, 2012

(54) Automated Window Enclosure

(76) Inventor: David Donald Piney, Oshawa (CA)

(21) Appl. No.: 13/390,886

(22) PCT Filed: Aug. 18, 2010
(86) PCT No.: PCT/IB10/53722

§ 371 Date: Feb. 16, 2012

(30) Foreign Application Priority Data
Aug. 17, 2009 (CA) 2705085

(51) Int. Cl. E05F 15/20; E06B 9/24; E06B 3/38; E06B 7/26; E05F 15/00; E05F 11/02

(52) U.S. Cl. 49/29; 49/324; 49/506; 49/31

(57) ABSTRACT

The concept of being able to turn window glass space into a virtual exterior wall with the touch of a switch is the conceptual basis of this device. These six inch thick, exterior mounted, Window Enclosure panels are designed to close securely with their insulated frame in order to optimize energy efficiency, and achieve unprecedented building security. These fully automated panels can be programmed to close from dusk to dawn for example, or when the building is expected to be unoccupied—away at work, on vacation, etc. And security cameras and other devices are readily integrated, permitting the panels to respond to weather and security events when nobody's home, such as perimeter intrusion, barometric anomalies, target temperatures (beneficial or adverse), etc. As well, most models act as an awning in the raised position, and can be quickly adjusted to shield direct sunlight, or to fully harvest it, naturally.

### TECHNICAL FIELD

I'll need WIPO technical counciling to determine this field.

### BACKGROUND ART

The background art in Canadian patents for dealing with the inherent frailty of window glass has largely overlooked the energy-loss element, which is only now being fully recognized with the depletion of global oil reserves. Although there are many storm shutter patents listed in the patent databases—which is the closest relative to the device described herein—there's nothing of the type nor magnitude that this patent application offers within the databases that I searched.

### DISCLOSURE OF INVENTION

### Summary

The concept of being able to turn window glass space in buildings into a virtual exterior wall with the touch of a switch is the conceptual basis of this device, which promises to redefine the way daylight is used for interior lighting purposes during extreme weather days (hot or cold), as well as to offer unprecedented building security. These six inch thick exterior mounted window enclosure panels are designed to close securely with their insulated frame, which is thermally bonded to the building around the respective window in retrofits, and built-in to new construction projects, in order to optimize energy efficiency while achieving unprecedented building security—fully automated!

All Window Enclosure models will have control panels on the interior wall beside the enclosed window, which utilize conventional wireless technology to facilitate Window Enclosure programming and position coordination options building-wide. Thus the enclosure panels can be conveniently opened, closed, or programmed throughout the building, as required, from any control panel that management designates in its desired central control grouping(s). The panels are usually programmed to close from dusk to dawn, or when the building is expected to be unoccupied—away at work, on vacation, etc. And provisions are made for multiple electronic devices to integrate, such as security cameras for example, permitting the panels to close when sensors detect a perimeter intrusion; an electronic barometer will be able to close panels when a threatening storm approaches and temperature sensors, indoors and out, permit building management to program panels to respond to weather conditions even if nobodys home.

As well, most models act as an awning in the raised position, and the motorized panels can quickly be adjusted to either shield direct sunlight into the window or to fully harvest it, naturally. The air conditioning energy savings from Window Enclosure awning positioning preventing direct sunlight into windows is significant during hot summer days.

### DISCLOSURE OF INVENTION

### Details

The basic materials for (all models) panel core construction will vary according to regional weather conditions, material availability and custom security needs; but basically the panels will achieve an R-30 rating with 6″ of SM Styrofoam, with heavy gauge security wire welded to the steel/aluminum frame face, and fully enclosed within a molded heavy gauge plastic skin. When closed these Window Enclosure panels offer no building intrusion opportunities short of using demolition tools, which would make exterior walls of most buildings equally vulnerable. Thus, in effect, their security and thermal resistance attributes are exterior wall equivalent. As well, most models will offer a vacuum luminesent portal option (FIG. 24), in order to permit sufficient daylight into rooms when the Window Enclosures are closed to be functional, thus enabling target rooms to remain closed throughout entire extreme weather periods.

Fold up models.

The Fold up models are a simple solution to mitigate the wind load forces that large Window

Enclosures suffer when parked in the awning position, thus reducing the need for reinforcing materials in manufacture. As well the fold up models are suited for restrictive overhang applications.

In the case of the threaded rod driven Fold up models depicted in FIG. 3, two horizontally hinged panels rise by the lower panel's (FIG. 2-1) frame (FIG. 2-3) corners, which are pivot anchored (FIG. 2 joint#2) to Specialty nuts (FIG. 4. Diag.#2-2), travelling on rotating threaded rods (FIG. 4.Diag#2-3)—which are mounted vertically in the rigid exterior frame (FIG. 4-1), and are geared together with the horizontal rod (FIG. 4-5) and coupling gears (FIG. 4-4) so as to be driven by the motor/hand crank assembly (FIG. 4-3) primary threaded rod (FIG. 4-6, FIG. 8-8) thus facilitating the hand-crank capability, which requires a single-drive mechanism. The upper panel (FIG. 2-2) is hinged with the top of the rigid external frame (FIG. 6-1) so the two panels fold outward from the window at their centre hinge as the bottom panel rises from its vertical to horizontal axis, which is the fully open position; and then because of specially designed hinge joints (FIG. 2 joint#1) the panel is able to rise further, thus both panels now folded tightly together are able to flop downward, to present adjustable angles to the sun typical with conventional awnings, as required.

The panels close the same way. The upper panel is hinged to allow its trailing edge to seat snugly with the molded plastic gasket (FIG. 5-3) of the rigid frame as it closes; the middle hinge, joining the two panels, pivots on the inside surface of the panel frame, allowing them to fold together in the enclosure “open” position (FIG. 2 joint#1); as well, the trailing ends of the square edged panels butt tightly as they close (one of which uses a soft rubber gasket to facilitate snug closure (FIG. 2-4)). The lower panel is designed to seat snugly with the bottom gasket (FIG. 7 & FIG. 9) of the rigid exterior frame. There are specialty molded gasket-junction sections in the corners to converge the rigid exterior frame side gaskets to the rigid exterior frame top and bottom gaskets (FIG. 9.Diag.#B), which also provide a bug, water barrier.

Mere inches before the panels fully close, the engagement arm (FIG. 4.Diag.#2-4)—part of the panel frame mount (FIG. 4.diag.#2-1) riding on the rotating threaded rod (FIG. 4.diag.#2-3)—contacts the folding mounting bracket (FIG. 4.diag.#2-5, which stands the threaded rod off the seating position) at its fulcrum, thus dragging it closed and forcing a tight seal between the panels and their correspondingly bevelled gaskets. This engagement arm has a forked head (FIG. 4.diag.#3-1) with inner and outer spring-steel gripper flanges (FIG. 4.diag.#3-2) that grasp the fulcrum of the folding bracket as it is forced closed, thus aiding its return spring in dragging the folding bracket to its open position by the retreating panel frame mount as the motor or crank reverses direction in order to open the cover.

The Single panel model.

The threaded rod driven Single panel model (FIG. 1), with window heights of only a few feet, is largely the same design as the Fold up model except that it uses a single panel construction and only one rotating threaded rod. Otherwise, the rigid exterior frame, panel construction and seating molding is identical. The outside edge, of the top panel, is hinged to the top of the rigid exterior frame, as is the Fold up window model,but the motor/crank assembly (FIG. 21.-1) turns the primary threaded rod, which in this model, engages the swivel-coupling nut (FIG. 21.-4), which directly raises the panel frame (FIG. 21.-2) lever arm (FIG. 21.-3) and thus the panel.

Chain Driven models

In the case of the Fold up Chain Driven model depicted in FIG. 3, two horizontally hinged panels rise by the lower panel (FIG. 2-1) frame (FIG. 2-3) corners, which are pivot anchored (FIG. 2 joint #2) to the drive chain (FIG. 13-1) on each side of the exterior frame [mounted vertically in the rigid exterior frame between the base sprocket (FIG. 20-1, FIG. 13-4) and the horizontal drive rod (FIG. 13-5) sprockets (FIG. 13-2), thus gearing both sides together so as to be driven by the motor/hand crank assembly (FIG. 13-3) primary drive chain (FIG. 13-6)—thus facilitating the hand-crank capability, which requires a single-drive mechanism]. The chain is kept taught by the tension pivot adjustment (FIG. 20-2). The upper panel (FIG. 2-2) is hinged with the top of the rigid exterior frame (FIG. 6-1) so the two panels fold outward from the window at their centre hinge as the bottom panel rises from its vertical to horizontal axis, which is the fully open position; and then because of specially designed hinge joints (FIG. 2 joint#1) the panel is able to rise further, thus both panels now folded tightly together are able to flop downward, to present adjustable angles to the sun typical with conventional awnings, as required.

The panels close the same way; the upper panel is hinged to allow its trailing edge to seat snugly with the molded plastic gasket (FIG. 5-3) of the rigid frame (FIG. 4-2) as it closes; the middle hinge, joining the two panels, pivots on the inside surface of the panel frame, allowing them to fold together in the “open” position (FIG. 2 joint#1), as well, the trailing ends of the square edged panels butt tightly as they close (one of which uses a soft rubber gasket to facilitate snug closure (FIG. 2-4)). The lower panel is designed to seat tightly with the bottom gasket (FIG. 7 & FIG. 9) of the rigid exterior frame. There are Specialty molded gasket-junction sections in the corners to converge the rigid exterior frame side gaskets to the rigid exterior frame top and bottom gaskets (FIG. 9.Diag.#B), which also provide a bug, water barrier.

Mere inches before the panels fully close, the engagement arm (FIG. 20-5)—part of the panel frame mount (FIG. 20-6) mounted to the drive chain-contacts the folding mounting bracket (FIG. 20-3) (which stands the lower drive sprocket off the panel seating position) at its fulcrum, thus dragging it closed and forcing a tight seal between the panels and their correspondingly bevelled gaskets—with minimum gasket or panel abrasion. This engagement arm has a forked head (FIG. 4.diag.#3-1) with inner and outer spring-steel gripper flanges (FIG. 4.diag.#3-2) that grasp the fulcrum of the folding bracket as it is forced closed, thus aiding its return spring (FIG. 20-4) in dragging the folding bracket to its open position by the retreating panel frame mount as the motor or crank reverses chain direction in order to open the cover.

Single panel Chain Driven model.

The Single panel Chain Driven model (FIG. 1), with heights less than 4 feet, is largely the same design as the fold up model except that it uses a single panel construction and only a primary drive chain. Otherwise, the rigid exterior frame, panel construction and gasket seats are identical. The outside edge of the top panel is hinged to the top of the rigid exterior frame, as is the fold up model, but the motor/crank assembly (FIG. 22) turns the primary drive chain, which 155 in this model directly raises the enclosure panel. The motor (FIG. 15-1) or the hand crank (FIG. 22) turns the gear cluster (FIG. 15-7) which drives the chain sprocket (FIG. 15-6) and thus the drive chain (FIG. 15-4) which turns the fixed frame sprocket (FIG. 15-3) and opens the panel. FIG. 15-5 shows the panel frame end bearing mount.

The crank handle mechanism.

As an important safety feature, low rise buildings where emergency escape from windows is possible, a no power hand crank mechanism will be included. The crank handle mechanism (FIG. #8) conveniently protrudes from the interior wall-mounted control panel (FIG. 8-1), directly beside the window that's enclosed, in all residential models (low rise buildings permitting window emergency escape). As the threaded rod model crank handle (FIG. #8-2) is turned in the “open” direction the telescoping crank handle /shaft joint (slotted fit, FIG. #8-6) allows the shaft to advance by its acme threads (FIG. #8-5) pushing the platform motor gear (FIG. #8-7) out of the threaded rod gear circuit (FIG. #8-9, via the electric motor floating-platform/ floating-guide interface of the fixed-bracket assembly listed in FIG. 8), and pushing the hand-crank gear (FIG. #8-3) to mesh instead. The shaft has a machined idle position designed to float inside the advancement nut (FIG. #8-10) as the acme threads exit it in the shaft-advanced position. Even though they ride directly against each other, the heavy acme thread face will suffer little wear against the advancement nut face in the fully advanced position as the crank handle is continually turned to open the panel(s), because this emergency (hand crank) procedure will not be commonly applied. When the panel(s) is/are raised to the “awning position” the crank handle is turned one rotation in the opposite direction—to reset the system to the motorized position—thus the floating platform return spring (FIG. #8-4) reengages the acme threads on the crank shaft with the advancement nut, retracting the crank shaft and the floating platform, thus re-engaging the motor gear. The crank shaft bushing is shown in FIG. 8-11. The chain driven hand crank model differs slightly from the threaded drive model, shown in FIG. 22-9, where a chain drive sprocket replaces the threaded rod coupling gear circuit. As well, the hydraulic hand crank model differs slightly from the threaded model rod model, shown in FIG. 17, where the hydraulic pump and drive gears replace the threaded rod coupling gear circuit.

Hydraulic ram driven model.

Hydraulic ram driven models will be typically offered to consumers in the Single panel, the Shutter model and Fold up designs, as well as both Window Array models.

In the case of the Fold up model depicted in FIG. 18, two horizontally hinged panels (FIG. 16C) rise separately by hydraulic ram (FIG. 16). The rams (FIG. 16-1, 16-4), pump (FIG. 16-3) and hydraulic lines (FIG. 16-2) mount to the panel frame. The upper panel opens first by the upper ram pressing the panel Frame Lever Arm (FIG. 16C-1) to the open position (as in the Single Panel Model FIG. 19). In automated mode, the Open Position Shutoff Switch is activated when the upper panel Frame Lever Arm contacts it in the fully open position. Thus the lower panel rams activate, pushing the lower panel Frame Lever Arm (FIG. 16C-1-b) through the guiding slots in the vertical posts (FIG. 16B), directing the arm to its upper seat position and simultaneously positioning the lower panel Frame Guides to emerge from the Vertical Post Slots at the “open” junction (FIG. 16B-3). Continuing pressure from the lower rams on the panel Frame Lever Arm begins the panel arc from the vertical to horizontal (“open”) position. In automated mode, the Full Open Position Shutoff Switch is activated when the lower panel Frame Lever Arm contacts it, preventing further opening by timer, but the On-Demand Switch mode is not affected and will custom move the lower panel to its ram limits to optimize awning positioning if required. In closing, the lower panel rams activate first (via the “close” electrical circuit); contained by the bulbous seat guides (FIG. 16B-1) the lower panel Frame Lever Arm remains seated in position swinging the lower panel frame guides (FIG. 16C-2) back into the Vertical Post Slots at the “open” junction (FIG. 16B-3). The rams' continued contraction drops the lower panel Frame Guides down the Vertical Post Slots to the closed position seat, which contacts the Closed Position Shut Off Switch. The upper panel ram then activates via the dual switch, closing the upper panel until it contacts its Closed Position Shutoff Switch.

Single panel hydraulic model.

The single panel hydraulic model (FIG. 58-B & E) operates exactly the same as the upper panel in the fold up hydraulic model, but does not disengage the on-demand electric switch circuit (as the dual panel fold up model does) when fully opened by the pre-programming circuit; thus the electric switch will move the panel from its upper limits as required for on-demand custom awning control. In order to open the panel the ram (FIG. 19-1) pushes against the panel frame lever arm (FIG. 19-3) which raises entire frame (FIG. 19-2) to the open position until the shutoff switch (FIG. 19-6) is contacted by the frame arm switch contact protrusion (FIG. 19-5). The panel is lowered, or its awning position adjusted, the same way, until the switch contact protrusion contacts the lower shutoff switch (FIG. 19-7).

Because of the unique aesthetics involved in commercial structures, the awning position of the window enclosure panels must be automatically coordinated in order to ensure perfect window array uniformity. Thus we'll include laser levelling devices in the automated panel opening circuit.

The Single panel Window Array hydraulic model.

The Single panel Window Array model. is designed for commercial buildings where window bank type construction prevails. Thus a Window Enclosure seating gasket frame is installed around the periphery of the entire window bank to be enclosed (FIG. 36-G). In this case 5 windows are enclosed in FIG. 37-D. The panels are constructed with tension cables, designed to retain panel square in a lightweight frame, and are typically sandwiched with 6″of SM foam, faced with heavy gauge security wire, and surrounded by an aluminium or molded plastic skin. This model operates exactly like the single window hydraulic model except its enclosure panel is typically ram driven from both vertical posts (FIG. 37-F), as well as where structurally required (FIG. 36 orange rams) in order to lighten panel construction (drive shaft diameter) (FIG. 38-B). Thus the single panel encloses the entire bank as if it was one window (FIG. 36-E—i.e. the red coloured outer periphery of the single panel window array model enclosure panel poised above the window bank to be enclosed). Only a single control panel is mounted interior to this window array.

The motor/crank assembly (FIG. 17) turns the hydraulic pump, which engages the ram at the swivel-coupling nut (FIG. 21-4) directly raising the panel frame (FIG. 21-2) lever arm (FIG. 21-3) and thus the panel

The Fold up Window Array Enclosure model.

The fold up design Window Array Enclosure model operates exactly like the model mounted on residential windows but is designed for commercial applications where window bank construction prevails, and whose windows are too large for the single panel Window Array Enclosure design (because of severe wind gust stresses on their larger awning area). The drawing displayed in (FIG. 39) is applicable to either the threaded rod, or chain driven models, but a hydraulic driven Window Array Fold-up Model will also be offered (FIG. 34-A). Similar to the Single panel model, the fold up model panel seating gasket is only installed around the periphery of the window bank, as if it were one window (FIG. 36-G). And there's only a single control panel located interior to the window bank. The threaded rod Window Array model is much the same as its residential cousin. The motor (FIG. 38-A,39-A) drives the primary drive shaft which is geared through the coupling gears (FIG. 38-C) to the horizontal drive shaft (FIG. 39-B), and to the drive rods (FIG. 39-C, or chain sprockets in chain drive model) powering the enclosure panel anchor nut. FIG. 39-D is a single window in the drawing's 5 window array.

Shutter type Window Enclosure model.

This model is hinged vertically at each side of the window enclosure frame and utilizes the same gasket seating system and materials as the awning type window enclosure models. FIG. 56-A shows the shutter model closed, and FIG. 56-G shows it fully opened. When activated, the left panel ram (FIG. 56-E) opens fully first(FIG. 56-B) because it's tapered panel (FIG. 56-D), (side view FIG. 57-A-E) overlaps the right panel (FIG. 57-C) in order to thermally seal the seat (FIG. 57-D). When the left panel “open” switch is contacted, the right rams are activated, until the right panel (FIG. 56-F) triggers the “open” switch, which shuts off the hydraulic pump. The procedure to close reverses the order, activating the right panel first, then, once closed, activates the left. The switching mechanism is a simple feedback circuit that uses each panel's open/close switches to trigger transistors to facilitate the entire procedure, one step at a time.

The Slider Window Enclosure model.

The Slider panel model is designed to accommodate buildings where no awning function is required and where space is sufficient between windows to permit the panels to park in the “open” position: either above, below, or to either side of the window (FIG. 59-C). New construction projects are the most likely application for this model because custom designed window spacing is crucial for efficient placement; as well, instead of using an enclosure parking structure (FIG. 59-M)—required for retrofits—new construction can design a building facade specifically to both facilitate parking the slider panels within, invisibly, as well as incorporating that structure to optimize thermal and noise protection. The Slider panels (FIG. 59-B-I) are typically threaded rod driven (FIG. 59-A-H), and thus would use the folding mounting bracket/engagement arm (FIG. 59-F),concept to pull the panel snugly in to its seat (FIG. 59-G), (FIG. 59-D). As the closing panel engagement arms contact the folding arm anchor bracket (which stands the threaded rod off its seating position) it begins the folding up procedure at the hinged base (FIG. 59-E) and elbow joints (FIG. 59-J). Thus the threaded rod hinge at the motor end (FIG. 59-L) permits the entire panel assembly to seat with the external frame gasket. The engagement arm has a forked head the same as in FIG. 4.diag.#3-1, with inner and outer spring-steel gripper flanges (FIG. 4.diag.#3-2) that grasp the fulcrum of the folding bracket as it is forced closed, thus aiding its return spring in dragging the folding bracket to its open position by the retreating panel frame mount as the motor or crank reverses direction in order to open the cover.

Other slider models simply have a tapered fit with the exterior rigid frame to ensure a snug fit. As the last end closes the folding arm bracket closes snugly with the frame. The Slider panel model has identical bevelled sides, and corresponding bevelled seats in the rigid exterior frame molded gasket (FIG. 7-2, FIG. 5-3), as does the other Window Enclosure models.

Rigid exterior frame molded gasket.

The single panel model has identical bevelled sides, and corresponding bevelled seats in the rigid exterior frame molded gasket (FIG. 7-2, FIG. 5-3), as does the Fold up window model. The gasket seat take-up joint (FIG. 7-3, FIG. 5-1) permits using wear resistant, heavy weight, rigid plastic material (−50 mm.) while allowing the gasket to easily compress over 1 inch in order to harmonize the mating contours and thus thermally seal the panel/gasket junction.

Coupling /decoupling tool.

The custom coupling /decoupling tool (FIG. 5) is required for installation and servicing this unit, in order to access the screw-in gasket reinforcement mount (FIG. 5-2, FIG. 7-1) for dis-assembly, for example.

The motor.

The drive motor is designed rotate in the direction of the current polarity, and to shut off and reset when stalled (FIG. 11) as part of the panel seating mechanism for the threaded rod drive and chain drive models (thus compensating for an unscheduled usage—when panels are inadvertently left open—in order to reset the window position according to the timer program.)

Programmable timer.

When either timer (FIG. 11-1&2) is activated they connect their respective polarity to the power solenoid for a few seconds, thus the solenoid energizes its contact switch plunger (FIG. 11-12) accordingly, either extending upward to complete the upper circuits (FIG. 11-7), or extending downward to complete the lower circuits, thus emulating the current output polarity with the timer input polarity and triggering the “open or close” rotational direction to the motor. As the solenoid plunger contacts with the main circuits it draws its power from there, but can be interrupted by the bimetallic thermal-switch solenoid wire circuit (FIG. 11-8).

The stall /reset feature is predicated on the bimetallic thermal-switch (FIG. 11-11), which is cooled by the fan cowling port (FIG. 11-6) as the armature is turning. When the panel(s) seats and the armature stalls, the fan (FIG. 11-5, which is part of the fan /cowling assembly, FIG. 11-13, mounted to the armature shaft, FIG. 11-14) stops, and thus the bimetallic thermal-switch in the power circuit heats and opens; thus (through wire FIG. 11-8) the solenoid discharges and the spring-loaded plunger reverts to the neutral position, breaking the power circuit connection, so that when the bimetallic thermal-switch cools and closes (ready for the next cycle) the power source will have been disconnected.

The automated function of the system is two simple timers (store-bought) offering multiple daily selections to automatically open or close the panel(s) (ie. dusk to dawn, while at work, on vacation, etc.). These timer circuits deliver respective polarity current (for a few seconds) to the power solenoid (FIG. 11-3), whereby the plunger responds accordingly connecting the desired main circuits, thus facilitating the motor (FIG. 11-4) rotation direction, and the opening or closing of the panels. There is an auxiliary device interface plug here for wireless connections, electronic barometer, indoor/outdoor temperature sensors, perimeter infrared sensors, etc., to automatically trigger the opening or closure of the panels under all conceivable weather or security events according to building management options.

The electric switch opens or closes the panel(s) according to operator whim, thereby offering awning positioning, or even the partial opening or closing of panels through FIG. 11-9. The (slider type) electric switch (FIG. 12) is conveniently located on the inside wall control panel directly beside the enclosed window. When the spring-loaded switch cover (FIG. 12-2) is pushed off the neutral position in either direction (to open or to close panels) its electrical contacts (FIG. 12-1) join the positive in-terminal wiring to either out-terminal wiring configuration (FIG. 12-3) contacts (FIG. 12-4), and similarly the negative in-terminal wiring to the opposite polarity out-terminal wiring configuration (FIG. 12-3), thus directly controlling current polarity to the motor and thereby its rotation direction.

The electrical switch function is wholly operator controlled, and thus when the panel(s) seats the switch is released, thereby the spring-loaded mechanism returns it to the neutral position. The panel stall/reset mechanism is unnecessary in this (operator controlled) circuit, and is thus directly wired to the motor, bypassing the power solenoid.

### BRIEF DESCRIPTION OF DRAWINGS

FIG. 1; front view, single panel model, diag.#A reference.

FIG. 2; side view, dual panel model, Specialty hinge reference.

FIG. 2-1 lower fold up panel

FIG. 2-2 upper fold up panel

FIG. 2-3, fold up model frame

FIG. 2-4 snug closure rubber gasket

FIG. 3; front view, chain or rod drive, Fold up model.

FIG. 4; front view, threaded rod, rigid external frame (gaskets removed) reference.

FIG. 4-1, threaded rod drive

FIG. 4-2, Panel frame

FIG. 4-3, Electric motor

FIG. 4-4, Horizontal drive shaft link gears

FIG. 4-5, Horizontal drive shaft

FIG. 4-6, primary drive shaft

FIG. 4.diag.#2; side view, threaded rod drive, Fold up model, mount/seating mechanism reference.

FIG. 4.diag.#2-1, Panel frame anchor

FIG. 4.diag.#2-2, Specialty nut (frame anchor & drive)

FIG. 4.diag.#2-3, Rotating threaded rod

FIG. 4.diag.#2-4, Folding bracket engagement arm

FIG. 4.diag.#2-5, Folding mounting bracket

FIG. 4.diag.#3. side/top view, engagement arm reference.

FIG. 4.diag.#3-1, Engagement arm forked head

FIG. 4.diag.#3-2, spring-steel gripper flanges

FIG. 5. side view, rigid external frame gasket reference (sides and top).

FIG. 5-1, gasket seat take-up joint

FIG. 5-2, screw-in gasket reinforcement mount

FIG. 5-3, molded plastic gasket

FIG. 6. front view, threaded rod, rigid external frame mounts reference.

FIG. 6-1 upper panel hinge

FIG. 7. side view, rigid external frame bottom gasket reference.

FIG. 7-1, mounting brackets

FIG. 7-2, bevelled gasket face

FIG. 7-3, gasket take-up joint

FIG. 8. side view, threaded rod hand crank/motor assembly reference.

FIG. 8-1, interior wall mounted control panel

FIG. 8-2, Crank handle (for emergency no power enclosure opening)

FIG. 8-3, hand crank gear

FIG. 8-4, floating platform return spring

FIG. 8-5, (hand crank shaft advance) acme threads

FIG. 8-6, telescoping crank handle/shaft joint (slotted fit)

FIG. 8-7, platform motor (drive) gear

FIG. 8-9, drive gear circuit

FIG. 8-10, advancement nut

FIG. 8-11, crank shaft bushing

FIG. 9. front view, threaded rod, rigid exterior frame sides /bottom molded-gasket-junction reference.

FIG. 9.diag.#B. front view, showing junction take-up joints.

FIG. 11. schematic, motor direction, stall/ reset circuit.

FIG. 11- 1, Programmable timer (open)—with auxiliary connections (temperature sensor, security camera, barometer, wireless interface, etc.)

FIG. 11-2, Programmable timer (close)—with auxiliary connections (temperature sensor, security camera, barometer, wireless interface, etc.)

FIG. 11-3, power solenoid

FIG. 11-4, electric drive motor

FIG. 11-5, armature fan blades

FIG. 11-6, Fan exhaust cowling port

FIG. 11-7, solenoid upper contact circuits

FIG. 11-8, solenoid feed wire from bimetallic thermal switch circuit

FIG. 11-9, motor direction (on demand panel positioning) electric switch

FIG. 11-11, solenoid feed wire bimetallic thermal switch circuit

FIG. 11-12, electrical contacts, solenoid lower contact circuits

FIG. 12. schematic, motor direction electric switch.

FIG. 12-1, face plate contact terminals

FIG. 12-2, toggle (slider) face plate

FIG. 12-3, toggle base, wiring terminal junction

FIG. 12-4, switch contact terminals

FIG. 13. front view, chain drive, rigid external frame (gaskets removed) reference.

FIG. 13-1, threaded rod drive

FIG. 13-2, Horizontal drive shaft sprockets

FIG. 13-3, Electric drive motor

FIG. 13-4, Lower frame-mount sprockets

FIG. 13-5, Horizontal drive shaft

FIG. 13-6, primary drive chain

FIG. 15. front view, single panel model, chain drive, frame-lever reference.

FIG. 15-1, Electric motor

FIG. 15-2, Panel frame

FIG. 15-3, Frame drive sprocket 480

FIG. 15-4, Drive chain

FIG. 15-5, Frame drive bushing anchor

FIG. 15-6, drive sprocket circuit

FIG. 15-7, motor (drive) gear

FIG. 16. front view, hydraulic drive, rigid external frame (gaskets removed) reference.

FIG. 16-1, upper drive panel ram

FIG. 16-2, hydraulic line

FIG. 16- 3, hydraulic pump

FIG. 16- 4, lower panel drive rams

FIG. 16B. side view, Dual panel vertical guide posts, hydraulic drive.

FIG. 16B-1, Frame Guide Vertical Post Slots “bulbous” seat guides

FIG. 16B-1, lower panel frame guides

FIG. 16B-3, Frame Guide Vertical Post Slots “open” junction

FIG. 16C. top view, Dual panel frames, hydraulic model.

FIG. 16C-1, upper panel Frame Lever Arm

FIG. 16C-1b, lower panel Frame Lever Arm

FIG. 16C-2, lower panel frame anchor

FIG. 17. side view, hydraulic drive, hand crank/motor assembly reference.

FIG. 18. front view, Fold up model, hydraulic driven. (for patent public-display.)

FIG. 19. front view, Single panel model, hydraulic driven, frame-lever reference.

FIG. 19- 1, hydraulic ram

FIG. 19-2, single panel frame

FIG. 19-3, panel frame drive lever arm

FIG. 19-4, swivel nut coupling

FIG. 19-5, frame drive bushing mount

FIG. 19-6, panel open shutoff switch

FIG. 19-7, panel close shutoff switch

FIG. 20. side view, Fold up panel, chain drive, mount/seating mechanism reference.

FIG. 20-1, lower drive chain sprocket

FIG. 20-2, chain tension/pivot adjustment

FIG. 20-3, sprocket standoff assembly

FIG. 20-4, sprocket standoff bracket fulcrum

FIG. 20-5, panel frame mount engagement arm

FIG. 20-6, panel frame mount

FIG. 21. front view, Single panel, threaded rod drive.

FIG. 21-1, motor/crank assembly.

FIG. 21-2, single panel frame

FIG. 21-3, frame lever arm

FIG. 21-4, arm swivel nut junction

FIG. 22. side view, chain drive, hand crank/motor assembly reference.

FIG. 22-9, chain drive sprocket

FIG. 23; front view, vacuum luminecent portal insert, made from two vacuum panels (FIG. 27) sandwiched together with insulating air space between.

FIG. 24; front view; single panel model, with vacuum luminescent portal installed (FIG. 24-a). All models will offer the option of these portals.

FIG. 24A; front view; single vacuum luminescent panel.

Fig.-A; plexiglass facer plate (often coloured).

Fig.-B; one of two (in this case) glass vacuum tubes dipped in clear plastic resin and mounted in a urathane foam matrix in order to contruct an R-30 luminescent portal (FIG. 23.).

FIG. 35, front view, single panel, window array hydraulic model FIG. 35-A,

FIG. 36, front view, single panel, window array hydraulic model

FIG. 36-E, enclosure panel array frame

FIG. 37, front view, window array application, single enclosure panel, hydraulic driven.

FIG. 37-A, panels support /drive shaft, ram driven (FIG. -F) mounted to gasket seat frame by

Fig. -C, (in this drawing) 5 mounts.

FIG. 37-B, one of (in this drawing) 6 tapered (for lightweight strength) frame struts welded to the support (drive) shaft and anchor plate. (FIG. E).

FIG. 37-D, one of the windows in a 5 window (in this drawing) bank array.

FIG. 37-F; rams mounted at either end of driveshaft, positioned vertically

FIG. 37-H, tension extension cables, designed to retain panel square in lightweight frame. The insulated panels are typically a steel frame, sandwiched by 6″of SM foam, faced with heavy gauge security wire, and surrounded by an aluminium or molded plastic skin.

FIG. 38. front view, window array application, single enclosure panel, threaded rod driven.

FIG. 38-A motor.

FIG. 38-B drive shaft

FIG. 38-C coupling gears

FIG. 38-D one of 5 windows enclosed in this particular bank.

FIG. 38-E threaded rod drive, power geared from drive shaft(B)

FIG. 39. drawing top half; front view, window array application, dual panel fold up model. Drawing lower half; front view (when closed), window array application, insulated dual enclosure panels (exterior aluminium skin removed), fold up design.

FIG. 39-A electric motor, drives FIG. 39-B horizontal drive shaft, which is geared FIG. 39-C, to

FIG. 39-E the threaded rods (or chain sprockets in chain drive model). FIG. D is a single window in the drawing's 5 window array.

FIG. 39-F, in this case, one of 6 awning hinge joints anchoring the enclosure panels upper end to the seating gasket frame, which is bonded (via thermal gasket) to the building frame with bolts.

FIG. 39-G, tension cables designed to retain panel square in a lightweight frame.

FIG. 39-H, 6″ minimum SM foam insulation enclosed with aluminium skin.

FIG. 39-I, blue delineates the 2 insulated panels' periphery, hinged horizontally where they butt.

FIG. 39-J, seating gasket.

FIG. 39-K, one of 8 lower panel frame struts, there are 8 upper panel frame struts directly above them, enclosed by periphery frames for both panels.

FIG. 56, front view, shutter model window enclosure device.

FIG. 56-A, shutter model window enclosure device, closed position.

FIG. 56-B, left panel opened

FIG. 56-D, notation of staggered overlap method of thermally sealing panel closure joint (best clarified in FIG. 57)

FIG. 56-E, example of hydraulic ram location of lower left panel

FIG. 56-F, right panel opened

FIG. 56-G, fully opened shutter model window enclosure device.

FIG. 57, side view, shutter model, window enclosure device.

FIG. 57-B, left panel (noting overlap method of thermally sealing panels—with both the external frame seat and with each other—as they close).

FIG. 57-C, right panel, ?

FIG. 57-D, external rigid frame gasket seat.

FIG. 57-E, vertical hinges pivot point

FIG. 58, front view, 7 window enclosure model examples.

Fig. A, Fold up Window Array model, partially raised position.

Fig. B, Single panel Window Array model, partially raised position.

Fig. C, Fold up model, partially raised position.

Fig. D, Hydraulic Window Array model, partially raised position.

Fig. E, Single panel model, partially raised position.

Fig. F, Horizontal Slider panel model (left to right), fully opened position—(there are vertical models too; top to bottom, and bottom to top).

Fig. G, Shutter model, closed position.

FIG. 59, front and side view, Slider Window Enclosure model.

FIG. 59-A, front view, threaded rod (hidden behind open enclosure panel, and parking structure) noting its hinged joints and the folding mounting bracket which stands the whole enclosure panel assembly of its seat.

FIG. 59-B, Window Enclosure panel

FIG. 59-C, window

FIG. 59-D, external frame gasket

FIG. 59-E, fold up bracket anchor hinge

FIG. 59-F, engagement arm contact zone

FIG. 59-G, window enclosure panel, side view

FIG. 59-H, threaded rod drive

FIG. 59-I, window enclosure panel

FIG. 59-J, fold up bracket elbow hinge

FIG. 59-K, drive motor

FIG. 59-L, threaded rod geared junction

FIG. 59-M, window enclosure panel parking cover.

### BEST MODE FOR CARRYING OUT THE INVENTION

When security concerns aren't applicable these fully Automated Window Enclosure panels are typically set to close at night—especially in northern winters—and to open at sunrise, in order to take full advantage of window vistas and daylight transmission, yet conserve nighttime space heating energy. But during extreme weather periods, entire portions of the building Window Enclosure panels can be programmed to remain closed—little used rooms for example, or windward rooms during blizzard conditions, etc. Or panels can be programmed to only open when (supporting) temperature gauges reach certain thresholds for example, or to close when a connected barometer plummets, thus actively managing extreme weather as it occurs, even if nobody's home. As well, a simple connection with infrared security cameras will allow the automatic closing of panels when a perimeter intrusion is detected, thus making the building virtually impenetrable before potential harm arrives.

In hot weather conditions (if security conditions warrant) the Window Enclosure panels are best programmed open at night in order to cool the building and then to close target sections automatically as the day progresses—at certain temperature rises. This management strategy works very well, and in combination with the awning function of Window Enclosure panels, keeps buildings surprisingly cool during summer days, naturally.

Of course full window viewing can be restored anytime a user desires, with just the flick of a switch. And if the Enclosure panel is inadvertently left open, it will automatically return to its regular programming during the next cycle.

### INDUSTRIAL APPLICABILITY

The features outlined above are equally valuable to all building management sectors, whether residential, commercial or industrial. Thus industrial buildings will welcome the retrofit too. And I'm sure many more uses of the technology will arise as people fully integrate it into their everyday lives.

The embodiment of the invention in which an exclusive property or privilege is claimed are defined as follows:

1. The concept of being able to turn window glass space in buildings into a virtual exterior wall with the touch of a switch is the conceptual basis of this claim, and promises to redefine the way daylight is used for interior lighting purposes during extreme weather days (hot of cold), as well as to offer unprecedented building security.

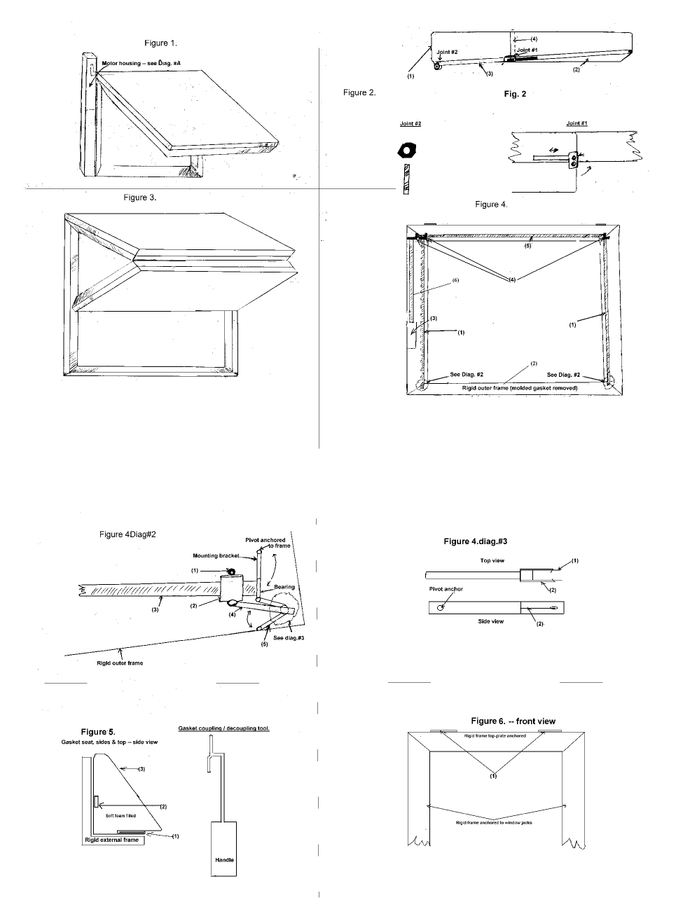

2. As well, this device can be programmed by timer to convert from providing window glass space to become a virtual exterior wall on what ever schedule building management chooses; typically after sunset for example, especially in northern winters; or when nobody is expected to be home, at work, school, etc.: or if the device is linked to electronic sensors (FIG. 11-1, 11-2), such as security infrared cameras, electronic barometers, temperature sensors (indoors and outdoors), etc., it's possible open or close the entire building Enclosure panels if security or weather conditions warrant, even if nobody's home. This powerful function helps better define the conceptual basis of this claim. And of course the device can automatically restore the building window glass area too, according to the programming schedule—typically at sunrise for example; as the family returns home from work, or school; or as the outdoor ambient temperature rises to acceptable levels, etc.

3. These fully automated, exterior wall-type, Window Enclosure panels, seen in FIG. 58-A-B-C-D-E-F-G as examples, are structurally designed to close securely with their insulated frame—which is thermally bonded to the building around the respective window in retrofits, and is built-in to new construction projects—in order to optimize building thermal efficiency and impenetrability security, and is the nuts and bolts basis for this claim.

4. And the purposeful low profile of the bottom gasket and rigid exterior frame bottom facilitate closing panels and in pushing out remaining drifted snow residue, thus ensuring an unobstructed tight seal between the panel and the gaskets is also claimed.

5. As well, the steeply bevelled molded gasket seats (FIG. 5, 9) are designed to run off water thoroughly, including melted snow remnants trapped within the closed panels, thus ensuring the especially sturdy (security conscious) motor/crank mechanism can easily overcome any freeze-up bonds that may occur due to unavoidable condensation, etc. and are claimed as such.

6. The fold up design Window Array Enclosure model is also claimed, which operates exactly like the residential Fold up model, but is designed for commercial applications where window bank construction prevails, and whose windows are too large for the single panel Window Array Enclosure design (because of severe wind gust stresses on their larger awning area). The drawing displayed in (FIG. 39) is applicable to either the threaded rod, or chain driven models, which are also hereby claimed, but a hydraulic driven Window Array Fold-up Model will also be offered (FIG. 58-A) and is claimed as such. Similar to the Single panel model, the Fold up Window Array model seating gasket is only installed around the periphery of the window bank, as if it were one window (FIG. 36-G) and is hereby claimed as a solution to commercial building retrofits.

7. The Single panel, Window Array model is designed for commercial buildings where window bank type construction prevails. Thus a Window Enclosure seating gasket frame is installed around the periphery of the entire window bank to be enclosed (FIG. 36-G). This model operates exactly like the single window hydraulic model except its enclosure panel is ram driven from both vertical posts (FIG. 37-F), as well as where structurally required according to length in order to lighten panel construction (especially drive shaft diameter) (FIG. 38-B). Thus the single panel encloses the entire bank as if it was one window (FIG. 36-E) and is hereby claimed.

8. All window enclosure models, single or dual panel (including window array models), have control panels installed on the interior wall directly beside the enclosed windows, which utilize conventional wireless technology to facilitate Window Enclosure programming and position coordination options
building-wide. Thus the enclosure panels can be conveniently opened, closed, or programmed throughout the building, as required, from any control panel that management designates in its desired grouping(s) and this system is hereby claimed.

9. The panels raise to an adjustable awning position to keep out unwanted direct sunlight, or adjust to permit its entry according to operator desire, made possible in the fold up design by the custom hinge joints (FIG. 2 joint #1) which are hereby claimed.

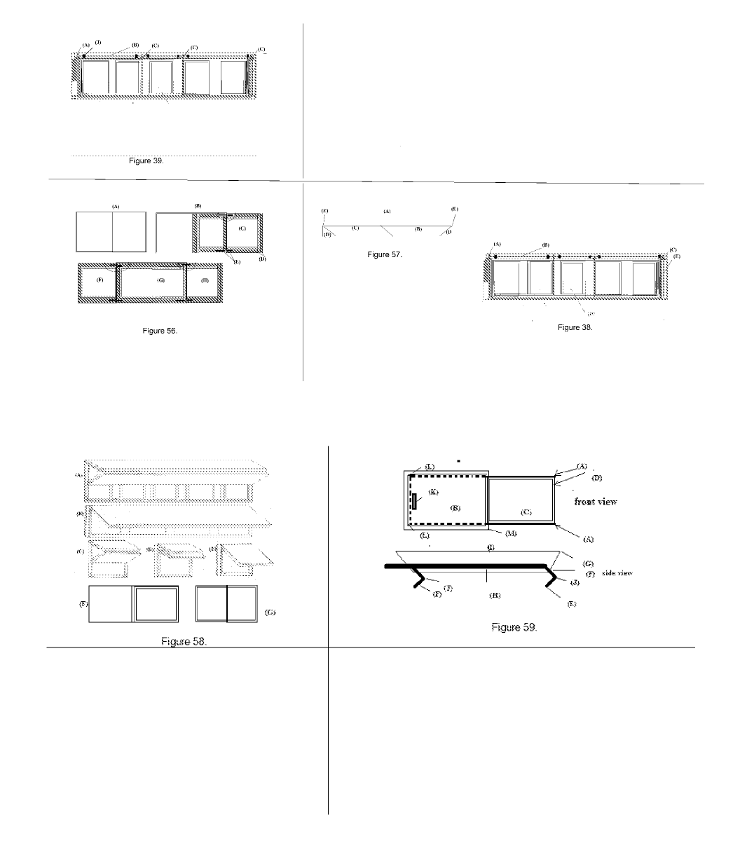

10. The Slider type window enclosure panel is also claimed, where an insulated window enclosure panel is designed into the building structure and slides into place (as opposed to swing into place) from above, below or to either side of the window, thus thermally sealing the window space with a virtual exterior wall panel when desired. In this example, a threaded rod drive mechanism (FIG. 59, K, L, A) advances the Slider panel from its parking housing FIG. 59-M) to snugly enclose the window in its seated position with the insulated frame. Other drive mechanisms may be used, as well as seating methods, but the concept of using a hidden exterior panel to slide into place to seal the window space with a virtual exterior wall is hereby claimed.

11. The no power, emergency, hand crank capability concept—for low rise buildings that permit emergency escape through windows (FIG. 8)—is hereby claimed.

12. The fully automated concept of closing from dusk to dawn, or when the building expected to be unoccupied, is claimed; as is closing particular (unused) rooms during harsh weather days when window view or natural lighting are secondary concerns, in order to help maximize building thermal efficiency is a unique concept and is hereby claimed.

13. The shutter model Window Enclosure device is hereby claimed (FIG. 56, A), whereby each vertically hinged panel (FIG. 56, C) is opened or closed in turn by hydraulic ram (FIG. 56, E) or other drive mechanisms.

14. The novel method of hinging motorized insulated panels from above the window, awning style (FIG. 58, A,B,C,D,E), not only protects the window from direct sunlight, if desired, but importantly protects snow from accumulating within the exterior rigid frame seats and is claimed.

15. The Fold up model and Slider panel model mechanical seating method (FIG. 3) prevents wear (on the panel bevel face and its molded gasket seat (FIG. 5) through abrasion—as they glide past each other opening and closing—by raising the panel completely off its seat almost instantly, and is hereby claimed. And is achieved in this instance by opening the folding mounting bracket (FIG. 4.diag.#2) that anchors the lower end of the rotating threaded rod bearing to the rigid exterior frame base (on one plane, with a pivoting upper bracket that anchors the threaded rod bearing to the rigid exterior frame wall, thus stabilizing the other plane; the other-upper—end of the rotating threaded rod pivot-mounts the bearing to the frame) thus raising the rotating threaded rod (with its Specialty nut, riding on the threaded rod carrying the panel frame mount) and therefore the panel: when closing, mere inches before the panels fully close, the engagement arm—part of the panel frame mount, riding on the threaded rod—contacts the folding mounting bracket (which stands the threaded rod off the seating position) at its fulcrum, thus dragging it closed and forcing a tight seal between the panels and their correspondingly bevelled gaskets.

16. This engagement arm (FIG. 4.diag.#2) has a forked-head guide (FIG. 4diag.#3) with inner and outer spring-steel gripper flanges, that grasp the fulcrum of the folding bracket as it is forced closed, thus aiding its return spring in dragging the folding bracket to its open position by the retreating panel frame mount as the motor or crank reverses direction in order to open the cover and is claimed.

17. The threaded rod driven Fold up Window Array model (FIG. 39) is hereby added to the patent claims.

18. The crank handle mechanism is claimed. It is turned in the “open” direction the telescoping crank handle /shaft joint (slotted fit) allows the shaft to advance by its acme threads thereby pushing the platform motor gear out of the threaded rod gear circuit and pushing the hand-crank gear to mesh instead; the hand crank shaft has a machined idle position designed to float inside the advancement nut as the acme threads exit it in the shaft-advanced position; even though they ride directly against each other, the heavy acme thread face will suffer little wear against the advancement nut face in the fully advanced position as the crank handle is continually turned to open the panel(s), because this emergency (hand crank) procedure will not be commonly applied; when the panels are raised to the “awning position” (or any height desired) the crank handle is turned one rotation (to its seat) in the opposite direction—in order to reset the system in the motorized position—thus the floating platform return spring re-engages the acme threads on the crank shaft with the advancement nut, retracting the crank shaft and the floating platform, thus re-engaging the motor gear.

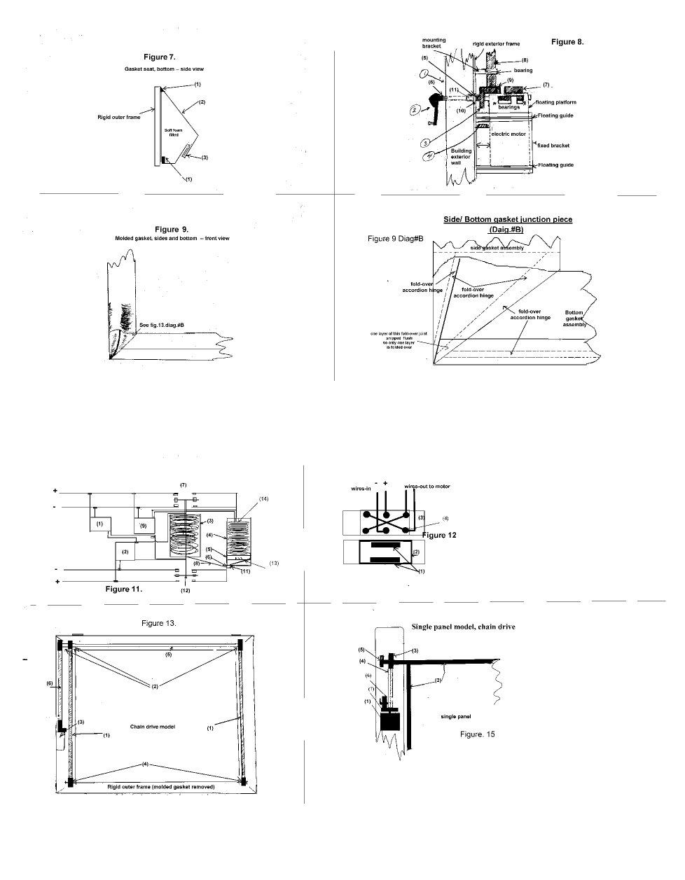

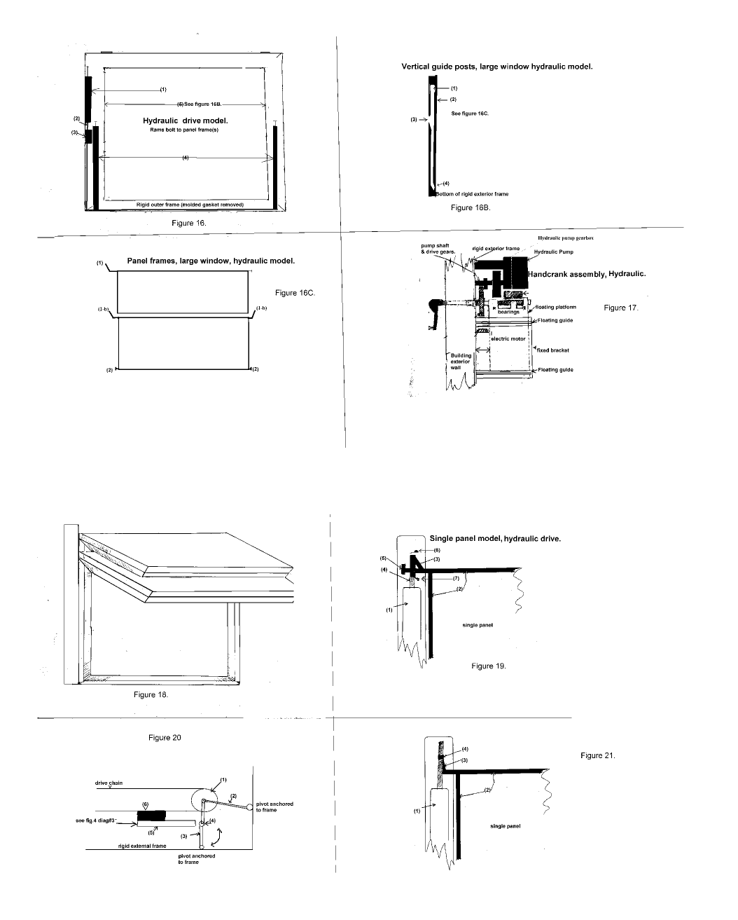

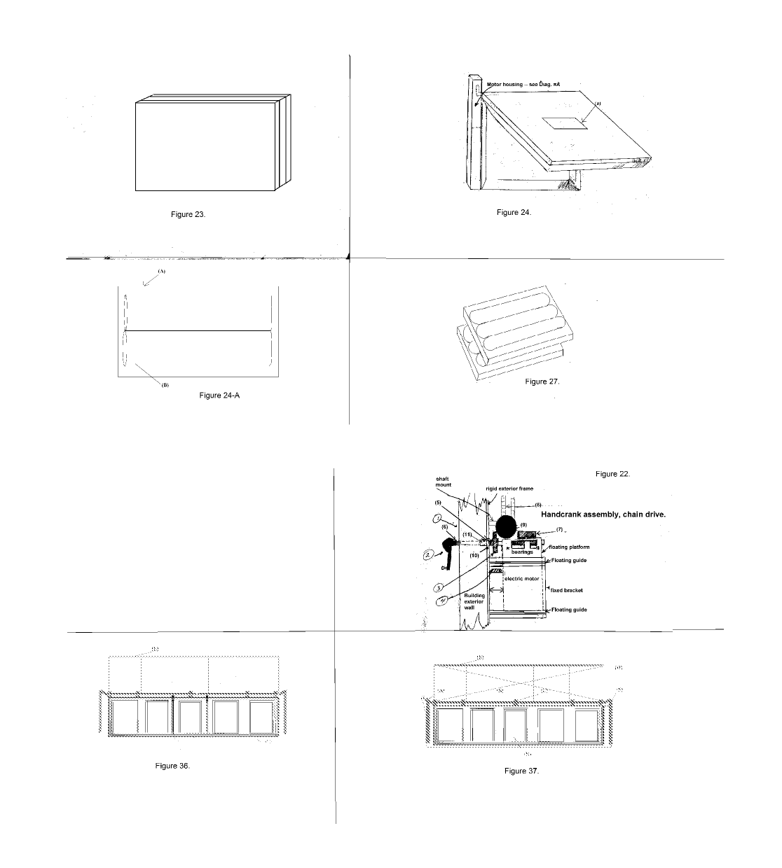

19. The motor is designed rotate in the direction of current polarity, and to shut off and reset if stalled (FIG. 11), as part of the panel seating mechanism (thus compensating for an unscheduled usage—when panels are inadvertently left open—in order to reset the window position according to the timer program) and is claimed; when either timer is activated they connect their respective polarity to the power solenoid for a few seconds, thus the solenoid energizes its contact switch plunger (FIG. 11-12) accordingly, extending upwards, to complete the upper circuits (FIG. 11-7), or extending downward, to complete the lower circuits thus emulating the current output polarity with the timer input polarity and triggering the “open or close” rotational direction to the motor. As the solenoid plunger contacts the main circuits it begins drawing its energizing power from there, which can be interrupted by the bimetallic thermal-switch solenoid wire circuit (FIG. 11-8).

20. The stall/reset feature is predicated on a heat sensitive, bimetallic thermal-switch, which is part of a fan /cowling assembly we intend to manufacture, which is mounted to store-bought drive motors; the bimetallic thermal-switch is cooled in the fan cowling port, which concentrates airflow from the armature fan onto the bimetallic thermal-switch as the armature turns in either direction; when the panel(s) seats, and the armature stalls, the airflow stops, and thus the bimetallic thermal-switch heats and opens; thereby (through wire FIG. 11-8) the solenoid discharges and the spring-loaded plunger reverts to the neutral position, breaking the power circuit connection, so that when the bimetallic thermal-switch cools and closes (ready for the next cycle) the power source will have been disconnected. This system is hereby claimed.

21. The molded gaskets are an integral part of ensuring thermal efficiency, in combination with durable low-wear longevity, as well as providing a water and insect impenetrability barrier; the gasket take-up joints (FIG. 5) are a novel method of using heavy weight rigid plastic material (˜50 mm.) for gasket seats, yet permitting the otherwise rigid gasket to easily compress over 1 inch in order to harmonize the mating contours and snugly, thermally seal, the panel/gasket junction, and are claimed as a system.

22. The custom coupling/decoupling tool (FIG. 5) is required for installation and servicing the molded gaskets and is claimed.

23. The gasket soft foam filling is hot-wire cut, slightly larger than the molded gasket it fills, thus ensuring a tight fit with no air gaps, and an intrinsic outward tension to expand the gasket take-up joint to its perimeter, thus ensuring its optimum compression capability for gasket/panel junction-contouring as needed, and therefore an airtight, thermal fit and are claimed.

24. The use of hydraulic ram to open and close these Window Enclosure panels considerably increases their size and weight potential, thus permitting Window Array Enclosure with one large panel, which is especially applicable for commercial buildings. Both single panel and double panel (fold up models) are offered in this Window Array Enclosure application and are claimed.

25. Chain driven Window Enclosure models are hereby added to the patent claims for multiple inherent attributes.

26. The vacuum luminescent portal (FIG. 24) is hereby claimed. These vacuum glass tubes (FIG. 24A-B) are dipped in a clear plastic coating, then embedded in a urathane foam matrix and covered with a thermally resistant plastic face (FIG. 24A-A) in order to construct a luminescent panel. And two panels are sandwiched (FIG. 27) together, back to back, to form a luminescent portal (FIG. 23) with a high R-factor.
